(19) United States
(12) Patent Application Publication
(10) Pub. No.: US 2018/0004909 A1
(43) Pub. Date: Jan. 4, 2018

(54) CAREGIVER CONNECTED WEARABLE

(71) Applicant: KONINKLIJKE PHILIPS N.V., EINDHOVEN (NL)

(72) Inventors: John Cronin, Bonita Springs, FL (US); John Ames, Andover, MA (US)

(21) Appl. No.: 15/537,504

(22) PCT Filed: Dec. 18, 2015
(86) PCT No.: PCT/EP2015/080649

§ 371 Date: Jun. 19, 2017

Related U.S. Application Data
(60) Provisional application No. 62/094,879, filed on Dec. 19, 2014.

(30) Foreign Application Priority Data
Jun. 5, 2015 (EP) 15170841.9

(51) Int. Cl. G06F 19/00

(52) U.S. Cl. CPC G06F 19/3418; G06F 19/3468; G06F 19/3425; G06F 19/3462

(57) ABSTRACT

In various embodiments, a caregiver module is provided for use with a patient medical device, including a sensor to obtain a sensor signal related to the use of the patient medical device; an analog-to-digital converter to convert the sensor signal to corresponding sensor data; and a controller to transmit the sensor data to a wearable device, wherein the sensor data is transmitted in the same form as created by the converter. Various embodiments provide a wearable device for processing sensor data received from the caregiver module, including: memory storing processing instructions for interpreting sensor data of multiple types; and a processor to: receive configuration information associated with the caregiver module, receive sensor data of a first type from the caregiver module, and execute the processing instructions based on the configuration information, wherein the configuration information alters the operation of the processing instructions to interpret sensor data of the first type.

### CROSS-REFERENCE TO RELATED APPLICATIONS

The present application claims the priority benefit of U.S. provisional application No. 62/094,879 filed Dec. 19, 2014 and entitled “Caregiver Connected Wearable,” the disclosure of which is incorporated herein by reference for all purposes.

### TECHNICAL FIELD

Various embodiments described herein generally relate to wearable technology. More specifically, but not exclusively, various embodiments relate to pairing of patient wearable devices with caregiver wearable devices.

### BACKGROUND

Wearable technology may include any type of mobile electronic device that may be worn on the body, attached to or embedded in clothes and accessories of an individual, and currently existing in the consumer marketplace. Processors and sensors associated with the wearable technology may display, process or gather information. Such wearable technology has been used in a variety of areas, including monitoring health of the user as well as collecting other types of data and statistics. These types of devices may be readily available to the public and may be easily purchased by consumers. Examples of some wearable technology in the health arena include the FITBIT, NIKE+ FUELBAND, and APPLE WATCH devices.

Patient care communications systems allow caregivers the ability to monitor and provide assistance to patients, for example, in hospitals. Telemedicine refers to the use of medical information of the patient that is exchanged from one site to another using electronic communications. Telemedicine may be used to improve a clinical health status of the patient by providing medical assistance when needed. Telemedicine includes a variety of applications and services using video, email, mobile devices, wireless tools and other forms of telecommunications available.

### SUMMARY

Various embodiments described herein relate to caregiver module for use in conjunction with a patient medical device and a related method and non-transitory machine readable storage medium, the caregiver module including: a communications interface; a memory; a sensor configured to obtain a sensor signal related to the use of the patient medical device; an analog-to-digital converter configured to convert the sensor signal to corresponding sensor data; and a controller in communication with the communications interface, the memory, and the analog-to-digital converter, the controller being configured to transmit the sensor data to a wearable device via the communications interface, wherein the sensor data is transmitted in the same form as created by the analog-to-digital converter.

Various embodiments are described wherein the sensor signal is related to at least one of activation of an asthma inhaler, activation of an auto-injector, and opening of a pill bottle.

Various embodiments are described wherein: the memory includes configuration information for instructing the wearable device in how to process the sensor data, and the controller is configured to transmit the configuration information to the wearable device via the communications interface.

Various embodiments are described wherein the configuration information includes at least one rule for application by the caregiver wearable device.

Various embodiments are described wherein: the memory stores a server address, and the controller is configured to: transmit a registration message to the server address, and based on receiving a response to the registration message: extract a caregiver wearable device identifier from the response, and store the caregiver wearable device identifier in the memory, whereby transmission of the sensor data to a wearable device via the communications interface is performed based on the stored caregiver wearable device identifier.

Various embodiments are described wherein: the caregiver module further includes a user interface for communicating with a user of the patient medical device, and the controller is further configured to: in response to receiving an link approval request via the communications interface and associated with the caregiver wearable device, request an approval response from the user via the user interface, and transmit an indication of the user's approval response to the communications interface, whereby the response to the registration message is received after transmitting the indication of the user's approval.

Various embodiments are described wherein: the memory stores an identification of a physical location and an associated secondary caregiver wearable device, and the controller is further configured to: determine whether the caregiver module is currently located at the physical location, and when the caregiver module is currently located at the physical location, additionally transmit the sensor data to the secondary wearable device via the communications interface.

Various embodiments described herein relate to a wearable device for processing sensor data received from a caregiver module and a related method and non-transitory machine readable storage medium, the wearable device including: a communication interface; a memory storing processing instructions for interpreting sensor data of multiple types; and a processor in communication with the communication interface and the memory, the processor being configured to: receive configuration information associated with a caregiver module, receive, via the communications interface, sensor data of a first type from the caregiver module, and execute the processing instructions based on the received configuration information, wherein the configuration information alters the operation of the processing instructions to interpret sensor data of the first type.

Various embodiments are described wherein: the processing instructions define a rules engine, and the configuration information includes at least one rule for execution by the rules engine and that is specific to sensor data of the first type.

Various embodiments are described wherein: the processing instructions include first processing instructions for processing sensor data of the first type and second processing instructions for processing sensor data of the second type, and in execute the processing instructions based on the received configuration information, the processor is configured to execute the first processing instructions based on the configuration information indicating that the sensor data is of the first type.

Various embodiments are described wherein the processor is configured to receive the configuration information from the caregiver module via the communication interface using a short range wireless communication.

Various embodiments are described wherein the processor is configured to: receive an identification of a server from at least one of the caregiver module and an indicia associated with the caregiver module, and request the configuration information from the server based on receiving the identification of the server.

Various embodiments described herein relate to a kit including a caregiver module configured for attachment to a patient medical device and at least one of a patient medical device, a caregiver wearable device, and a linking indicia configured to be read by the caregiver wearable device and to cause a link to be created between the caregiver module and a caregiver wearable device.

Various embodiments are described wherein creation of the link includes providing the caregiver module with an identifier of the caregiver wearable device, whereby transmission of the sensor data to a wearable device via the communications interface is performed based on the stored caregiver wearable device identifier.

Various embodiments are described, wherein, in causing a link to be created, the linking indicia is configured to cause configuration instructions to be downloaded onto the caregiver wearable device, wherein the configuration instructions configure the caregiver wearable device to interpret the sensor data.

### BRIEF DESCRIPTION OF THE DRAWINGS

In order to better understand various example embodiments, reference is made to the accompanying drawings, wherein:

FIG. 1 illustrates an example system for providing a caregiver connected wearable;

FIG. 2A illustrates an example caregiver module;

FIG. 2B illustrates example base instructions for transmitting information from the caregiver module to the caregiver;

FIG. 2C illustrates example base instructions for receiving communications at the caregiver module;

FIG. 3A illustrates example base instructions for the caregiver module;

FIG. 3B illustrates example base instructions for the caregiver module for outgoing communications;

FIG. 4A illustrates example base instructions for the caregiver wearable device;

FIG. 4B illustrates an example caregiver GUI on the caregiver wearable device for asthma;

FIG. 5A illustrates example base instructions for the caregiver health device network;

FIG. 5B illustrates an example caregiver GUI on the caregiver wearable device for asthma;

FIG. 6 illustrates an example computing device architecture that may be utilized to implement various embodiments;

FIG. 7 illustrates an example caregiver wearable kit;

FIG. 8 illustrates an example method for a caregiver to remotely monitor and provide medical assistance for a patient;

FIG. 9 illustrates and example method for establishing and utilizing a link between a caregiver wearable device and a caregiver module;

FIG. 10 illustrates an example message exchange for establishing and utilizing a link between a caregiver wearable device and a caregiver module;

FIG. 11 illustrates an example rule set for a caregiver wearable to interpret received sensor data; and

FIG. 12 illustrates an alternative example message exchange for establishing and utilizing a link between a caregiver wearable device and a caregiver module.

### DETAILED DESCRIPTION

The description and drawings presented herein illustrate various principles. It will be appreciated that those skilled in the art will be able to devise various arrangements that, although not explicitly described or shown herein, embody these principles and are included within the scope of this disclosure. As used herein, the term, “or,” as used herein, refers to a non-exclusive or (i.e., and/or), unless otherwise indicated (e.g., “or else” or “or in the alternative”). Additionally, the various embodiments described herein are not necessarily mutually exclusive and may be combined to produce additional embodiments that incorporate the principles described herein.

It would be desirable to incorporate the use of the health devices with other systems or networks. For example, aside from merely monitoring a health condition of the patient, there may be a desire to implement use of various other devices, systems or networks based on the health condition of the patient. Subsequent information on the use of these devices, systems, or networks by the patient may also be desired so that the caregiver may better monitor the health condition of the user.

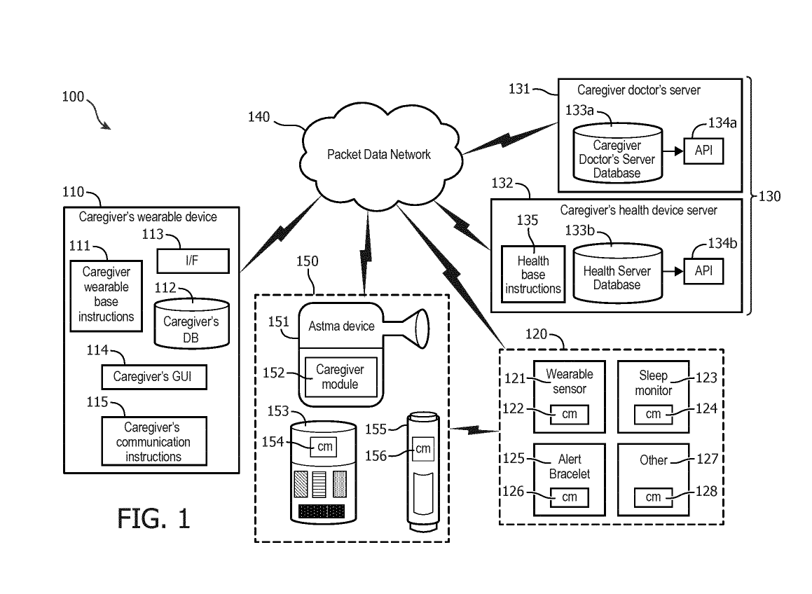

FIG. 1 illustrates an example system 100 for providing a caregiver connected wearable. As illustrated, a caregiver connected wearable device 110 is provided that may be used by a caregiver to remotely monitor not only the health condition of the patient, but also remotely monitor corresponding patient use of associated devices, systems, or networks directed at providing medical assistance. With respect to telemedicine, further assistance is provided to caregivers in monitoring and providing the medical assistance the patient may need.

As shown in FIG. 1, the system 100 may include a variety of different elements. These elements may include a caregiver wearable device 110, one or more patient wearable devices 120, and a plurality of caregiver servers (e.g., doctor, health device) 130. It should be noted that each of the elements of the system 100 may be connected to packet data network 140, such as a carrier network or the Internet. Communication between the various elements and with the packet data network 140 may be performed using communication methods known in the art (e.g., Wi-Fi, 3G, 4G, LTE, Bluetooth, NFC).

Also included in the example system 100 in FIG. 1 is an implementation of one or more caregiver devices 150 that may be used to provide remote medical assistance to the patient. Illustrated example implementations include an asthma device 151, a pill bottle 153, and an autoinjector 155 that are each provided with a respective caregiver module 152, 154, 156. It should be noted that other types of health devices (herein referred to as caregiver devices 150) may be used other than or in addition to these examples shown in FIG. 1. For example, syringes, medicine vials, insulin pumps, automatic external defibrillators, first aid kits, and other devices may be provided as caregiver device 150 and, as such, may include a caregiver module as will be described in greater detail below. Such other types of caregiver devices 150 may be used to remotely monitor and remotely provide medical assistance and/or treatment for one or more medical conditions that the patient may have.

The caregiver wearable device 110 may be used by a caregiver to remotely monitor a health condition of the patient and provide remote medical assistance as required based on information provided by the wearable device of the patient 120. It should be noted that the caregiver wearable device 110 may be a wearable device that may be worn on the body of the caregiver (e.g., via a wristband, a belt, or a necklace). In another embodiment, the caregiver wearable device 110 may be implemented as an application that may be downloaded and used on a mobile device (e.g., mobile phone or tablet) of the caregiver. In the example embodiment of FIG. 1, the caregiver wearable device 110 may include base instructions 111, a database 112, a communication interface 113, graphical user interface (GUI) 114, and communication instructions 115.

It will be understood that, while various embodiments are described herein as including instructions performing various functionality, that these instructions are embodied in hardware. As such, the various devices of FIG. 1 may include memory devices (not shown) for storing the described instructions and processors (not shown) for performing the functions described as being performed by the instructions. The memory devices may include various memories such as, for example L1, L2, or L3 cache; system memory; or storage devices including flash, magnetic, or optical storage. As used herein, the term “non-transitory” when used to describe storage media will be understood to encompass all such memory devices, whether volatile or non-volatile, while excluding mere transitory signals. As used herein, the processors may include microprocessor, field programmable gate array (FPGA), application-specific integrated circuit (ASIC), or other similar devices capable of performing the functions described herein. In some embodiments, such as embodiments using one or more ASIC, the functionality described as being provided by various instructions may be hardwired into the operation of one or more processor; in such embodiments, the corresponding instructions may be omitted and replaced with, for example, such special-purpose ASICs.

The base instructions 111 of the caregiver wearable device 110 may be implemented to manage and conduct the various functionalities of the caregiver wearable device 110. For example, the base instructions 111 of the caregiver wearable device 110 may be used to facilitate communication between the caregiver wearable device 110 and the wearable device of the patient 120. The base instructions 111 may also be used to obtain information from the caregiver device 150. The base instructions 111 may also be responsible for storing information obtained from one or more sources (e.g., the wearable device of the patient 120, the various caregiver networks 130, the caregiver device 150) into the database 112 found in the caregiver wearable device 110.

The caregiver database 112 may be used to store information used by the caregiver wearable device 110. Such information stored in the caregiver database 112 may include information regarding one or more patients, including the patient associated with the patient wearable device 120 including patient profile and contact information, medical history, information about the medical condition, and sensor data obtained from the wearable device 120 of the patient. As will be understood, the caregiver database 112, as well as other databases described herein, are embodied in physical hardware such as, for example, through storage in physical memory device as described above.

The communication interface 113 may be used by the caregiver wearable device 110 to communicate with other elements in the system 100 as noted above using various channels (e.g. Wi-Fi, 3G, 4G, LTE, Bluetooth, NFC).

The communication instructions 115 may be implemented to facilitate communication between the wearable device of the patient 120, the caregiver wearable device 110 and the various caregiver servers 130. The communication among the elements of the system 100 may include notification that information regarding the patient provided by the wearable device of the patient 120, the various caregiver networks 130 and the caregiver device 150 has been received and stored in the caregiver wearable device 110. The notification may be provided, for example, to the patient to confirm that the caregiver is monitoring the health condition of the patient and be implemented on the wearable device of the patient 120 alongside some form of acknowledgement (e.g., audio, visual or vibration) that may be perceived by the patient.

The caregiver GUI 114 may be used to inform the caregiver about various aspects of the health condition of the user. For example, information (e.g., sensor data) obtained from the wearable device 120 of the patient, the various caregiver servers 130 and/or the caregiver device 150 may be displayed on the GUI 114 for the caregiver to view. The GUI 114 may also be used to provide various inputs that may be directed to customizing medical assistance and/or treatment for a particular patient. For example, the GUI 114 may be used by the caregiver to connect to one or more of the available caregiver servers 130, for example, to request additional information about the patient or about a medical condition of the patient. The GUI 114 may also include features that facilitate communication between the caregiver and the patient. In various embodiments, the caregiver GUI 114, as well as other GUIs described herein, are defined by instructions for execution by a processor to interact with a user via one or more user interface hardware elements such as, for example, a display, a touchscreen, a camera, a speaker, a microphone, buttons, a keyboard, a keypad, or any other device for interacting with a user.

As noted above, the caregiver wearable device 110 may be in communication with a medical device 150. In some embodiments, this communication may occur via the wearable device of the patient 120. The wearable device of the patient 120 may be used by the caregiver to remotely monitor the health condition of the patient and remotely provide medical assistance as needed. As illustrated in the embodiment of FIG. 1, the wearable device of the patient 120 may include connections with a plurality of sensors 121 and various features for detecting and/or treating a particular medical condition. These sensors and various features for detecting (e.g., biometrics, vitals, or other measurements of the patient) and/or treating the medical condition may be incorporated into the wearable device of the patient 120 or may be distinct from, but in communication with, the wearable device of the patient 120. Example features that may be included in the wearable device of the patient 120 or connected with the wearable device of the patient 120 may include medicine, life alert systems, and monitors.

Each of the various medical devices 150 included in or in communication with the wearable device of the patient 120 or with the caregiver wearable device 110 may include a caregiver module 152, 154, 156. For example, a caregiver module 153 may be included in the cap of a prescription medicine bottle 153 to alert a caregiver when the bottle 153 is opened. Another caregiver module 156 may be implemented in an autoinjector 155 (e.g., an epinephrine or insulin autoinjector) to alert a caregiver when the autoinjector 155 has been activated. With the use of the caregiver module, the caregiver may receive information regarding use of the associated medicine by the patient (e.g., when the medicine was last taken, how frequently). The caregiver module may be instructed to provide other types of information as well (e.g., corresponding sensor data that may have necessitated the use of the prescription medicine).

Similarly, the one or more wearable devices 120 may include one or more devices provided with a caregiver module 122, 124, 126, 128 such as, for example, a wearable sensor 121, a sleep monitor 123, an alert bracelet 125, or other wearable device 127. In various embodiments, these caregiver modules 122, 124, 126, 128 may report data to the caregiver's wearable device 110 or server as an intermediary by facilitating communication between the caregiver module 152, 154, 156 of a medical device and the caregiver's wearable device. For example, the caregiver module 152 may detect activation of the asthma device 151 and transmit, via NFC or Bluetooth, an indication to the caregiver module 122 of the patient's wearable sensor 121 which, in turn, transmits the indication to the caregiver's wearable device using Wi-Fi or 4G communication via the packet network 140. It should be noted that there may be various other features incorporated with the wearable device of the patient 120. These additional embodiments may be used to facilitate remote monitoring and remote care from a caregiver with a connected caregiver wearable device 110. FIG. 1 is provided as an illustration of a possible example and is not intended to be exhaustive.

Also shown in FIG. 1 are example caregiver servers 130. The figure shows two example caregiver servers: a caregiver doctors servers 131 and a caregivers health device servers 132. It should be noted that other embodiments may include other types of servers that the caregiver may connect to.

Generally, each caregiver servers may include a database 133a,b and an application program interface (API) 134a,b. The database 133a,b may include information related to the subject matter of the network. The API 134a,b may allow various entities, such as the manufacturer of the wearable device or medical professionals, to upload information into appropriate networks based on the credentials of the entity. For example, the manufacturer may be allowed to upload information regarding the applicable wearable devices used in the system 100. On the other hand, medical professionals (e.g., doctors) may be allowed to input information regarding medical conditions. In another situation, the patient may be allowed to upload personal information (e.g., user profile, medical history) into the server.

The caregiver servers 130 may also include base instructions 135. The base instructions 135 may be implemented by a particular server to process and store information in the server. As will be understood, the caregiver servers 130 may belong to larger networks and, in some embodiments, may be implemented as one or more virtual machines in a cloud computing environment. For example, the health base instructions 135 may be executed by a first virtual machine while the health server database 133b may be stored and accessible via a second virtual machine.

As noted above, the caregiver device 150 may be used to provide remote medical assistance to the patient. The caregiver device 150 may be implemented with the system 100 to provide remote medical assistance for the patient. In various embodiments, the caregiver device 150 may be provided with one or more components that are operable to electrically or mechanically activate a function of a device. For example, in some embodiments, the pill bottle cap may include a lock mechanism to prevent opening of the bottle. Upon receiving an instruction from the caregiver's wearable device 110, the caregiver module 154 may unlock the cap (e.g., by activating a solenoid arranged to selectively lock and unlock the cap from rotation) and output an audible indication of the unlocking to allow access to the contents of the pill bottle. As another example, where the medical device 150 is an insulin pump (not shown), the respective caregiver module (not shown) may, upon receiving a signal from the caregiver's wearable device 110, output a signal to the pump mechanism to begin insulin delivery. The caregiver may also monitor usage of the caregiver device 150 by the patient.

The caregiver device 150 may be connected (e.g., wirelessly) to the wearable device 120 of the patient. Based on sensor data obtained from the wearable device 120 of the patient, the caregiver device 150 may be used to provide remote medical assistance. The caregiver device 150 may include a caregiver module 152 and a corresponding medical device 151 used to provide medical assistance to the patient. In FIG. 1, an asthma device 151 is associated with the caregiver module 152. It should be noted that one or more different types of medical devices 150 may be used to provide remote medical assistance to the patient based on sensor data obtained from the connected wearable device 120 of the patient or to provide use indications to the caregiver's wearable device 150.

The caregiver device 150 may include one or more sensors (not shown) that may be used to monitor the actions and health condition of the patient. For example, the asthma inhaler 151 of FIG. 1 may have sensors for sensing the use of asthma medication by the patient. Every time the patient uses asthma medication, the use information may be collected by the caregiver module 152. The use information obtained may then be transmitted to the caregiver wearable device 110 so that the caregiver may be informed that appropriate medical treatment has been provided based on a current health condition of the patient.

In various embodiments, the medical device 150 may not be provided with processing capability to process signals received from the sensors arranged to detect activation or other usage. In some such embodiments as well as other embodiments, the caregiver module 152, 154, 156 may transmit raw or partially processed sensor data for interpretation by the patient wearable device 120, caregiver's wearable device 110, or another device. For example, the caregiver module 152 may constantly report sensor readings to the wearable sensor 121 caregiver module 122 which, in turn, processes the sensor readings to determine when the data indicates device 151 activation and then forward the indication to the caregiver's wearable device. As another example, the caregiver module 156 of the autoinjector 155 may transmit sensor data from a trigger sensor being tripped to the caregiver's wearable device directly which, in turn, interprets the sensor data to indicate that the autoinjector 155 has been activated. In some embodiments, this report of raw sensor data may enable the use of a generic caregiver module among multiple types of devices; the caregiver module 152, 154, 156 may be provided with multiple sensors that are selected and positioned for the specific device and simply report those sensor readings to another device for interpretation. Such an arrangement may allow for reduced costs in manufacturing the devices 150, the ability to provide a generic caregiver module and modular sensors to an equipment manufacturer for incorporation into their product, or the ability to provide a generic caregiver module and appropriate sensors to a consumer as a kit to be attached to the device and thereby provide the functionality described herein.

In summary, the above example system 100 described in FIG. 1 may facilitate a caregiver to remotely monitor and remotely provide medical assistance to a patient through the use of wearable devices. The caregiver may monitor information regarding the health condition of the patient on a wearable device. The patient may be informed of potential occurrences of a medical condition and be instructed to take certain precautions or treatments based on the information from the wearable device of the patient. In particular, the wearable device of the patient may obtain sensor data used to evaluate the health condition of the patient and subsequently inform the user to take necessary steps to manage or treat a medical condition. The determination as to what the patient needs to do may be provided by the caregiver.

In another embodiment, it may be possible that the determination as to what the patient needs to do based on sensor data obtained by the wearable device of the patient may be provided by a processor stored on the wearable device of the patient or in some other location. The processor may be capable of evaluating the health condition of the patient by analyzing associated sensor data. The processor may also utilize various rules to determine whether medical assistance is required for the patient at any given time. If medical assistance is required and/or requested, the processor may provide instructions to the patient (for example, on the wearable device of the patient) to follow in order to minimize or treat the pending medical condition. In this embodiment, it may be possible that having a physical caregiver (an actual person serving as a caregiver for a patient) may be replaced by a computer. In other words, the computer may analyze the health condition of the user and remotely advise the user to perform some follow up actions (e.g., take medicine).

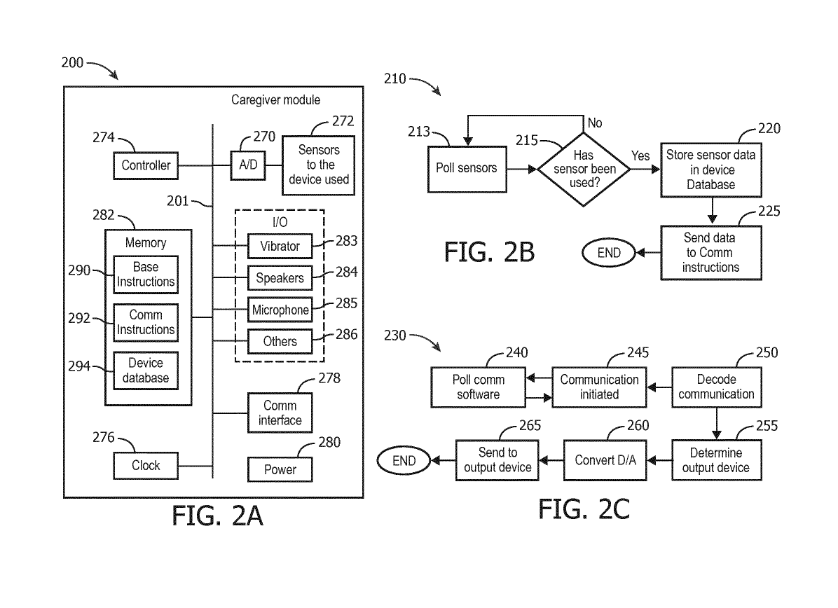

FIG. 2A illustrates an example caregiver module. As illustrated in FIG. 1, the caregiver module 200 may be incorporated in various features and devices usable by the patient to provide medical assistance or treatment for a medical condition. The caregiver module 200 may be incorporated to inform the caregiver about, for example, the “use” of the various features and devices by the patient.

As seen in the figure, the caregiver module 200 may include a central bus 201. The central bus 201 may be how the various components of the caregiver module 200 communicate among each other. It should be noted that the caregiver module 200 may have, in other embodiments, more than one bus for the purposes of providing a way for communication among the various components of the caregiver module 200; for example, a system bus may be connected to a peripheral bus via a peripheral bridge. In another embodiment, the central bus may also be implemented as a piece of hardware.

As indicated above, the caregiver module 200 may include various components for obtaining information from an associated caregiver device (e.g., asthma device) and informing the caregiver of the use of the caregiver device by the patient. The caregiver module 200 may include analog-to-digital (A/D) converters 270, one or more sensors 272, controllers 274, a clock 276, a communication interface 278, a power supply 280, memory 282, and input/output (I/O) hardware (e.g., vibrator 283, speaker 284, microphone 285, and other I/O hardware 286 such as displays, touchscreens, buttons, etc.). It should be noted that the memory of the caregiver module 200 may store instructions (e.g., base instructions 290 and communication instructions 292) and a device database 294 that may be used to operate the caregiver module.

Using the asthma device of FIG. 1 as an example embodiment, the caregiver module 200 of FIG. 2A may be associated with the asthma device to inform the caregiver of the use of the asthma device by the patient. The caregiver module may utilize one or more of its sensors 272 to monitor and record when the patient triggers or otherwise uses the medical device with which the caregiver module 200 is associated. A time stamp, from referencing the clock 276, may be associated with each use recorded use. Other types of information (e.g., sensor data from the wearable device of the patient) may also be collected and compiled with the “use” data relating to the asthma device. The “use” data may be stored in the caregiver module 200 in memory 282 until the caregiver requests the data to be provided. When the “use” data is requested, the caregiver module 200 may transmit the requested information using the communication interface using various communication methods (e.g., Wi-Fi, 3G, 4G, LTE, Bluetooth, NFC). In another embodiment, the caregiver module 200 may be instructed to provide the “use” information at intervals.

FIG. 2B illustrates example base instructions 210 for transmitting information from the caregiver module to the caregiver. For example, the steps illustrated in FIG. 2B may describe the steps taken by the base instructions to transmit information from the caregiver module to the caregiver wearable device.

In step 213, the base instructions of the caregiver module may begin polling for data from one or more sensors associated with the caregiver module. The sensors may be instructed to detect if the associated caregiver device (e.g., asthma device) has been used.

In step 215, the base instructions may poll for sensor data continuously or at regular intervals. The base instructions may also poll for a pre-defined period of time or at least until the base instructions detects applicable sensor data. In situations where a pre-defined period of time has elapsed without detected sensor data, the base instructions may terminate (not shown).

If sensor data is detected, the sensor data corresponding to a patient using the associated caregiver device may then be stored in memory (see step 220). The sensor data may be stored for future reference by the caregiver when requested. The stored data may also have an associated time stamp indicating when the patient used the caregiver device. The timestamp may be determined by referencing the clock associated with the caregiver module.

In step 225, the related data pertaining to use of the caregiver device by the patient may be provided to the caregiver. As indicated above, the transmission of this use data may be provided to the caregiver on request. The information may be provided to the wearable device of the caregiver upon request. In other embodiments, the information may be provided to the caregiver at regular intervals. After receipt, the information may be displayed on the wearable device of the caregiver. In this way, the caregiver may monitor the health condition of the user and possible medical assistance and/or treatments being taken.

FIG. 2C illustrates example base instructions 230 for incoming communications to the caregiver module. In various embodiments, the steps may illustrate how the caregiver module processes incoming communications to the caregiver module using the communication instructions.

In step 240, the base instructions of the caregiver module may poll the communication instructions for any available incoming information. Incoming information may be provided, for example, from the caregiver wearable device. This initial polling may also be used to determine if the communication instructions has been initiated.

In step 245, the communication instructions of the caregiver module is initiated if it has not done so yet. As indicated above, the communication instructions may be evaluated whether it has been initiated or not based on whether a response from the communication instructions has been provide to the polling of the base instructions in step 240. In an embodiment of the present disclosure, the communication instructions may be automatically initiated if a pre-defined time period has elapsed during which the base instructions polled for a response and received none by the communication instructions. Once the communication instructions has been initiated, a communication channel may be formed between the caregiver module and a source of the incoming information that was polled in step 240.

In step 250, once the communication instructions has been initiated, the base instructions may proceed with decoding the various incoming communications to the wearable device of the patient. It should be noted that the base instructions of the caregiver module may also determine which output device to use, decode incoming communications (e.g., from the patient, user, plurality of caregiver networks) using a converter and then transmit the communication to be outputted through the chosen output device.

In step 255, the base instructions of the caregiver module may select an appropriate output device to inform the patient and/or caregiver of the obtained information. In particular, the information may be displayed on the wearable device of the patient and/or caregiver. In another embodiment, the information may be provided over a speaker (e.g., a personal digital assistant may orally provide the information). In another embodiment, sensors may be provided to inform the caregiver regarding receipt of the information. For example, a wearable device of the caregiver may be instructed to “vibrate” upon receipt of sensor data and a stronger vibration may be implemented upon receipt of emergency conditions. Particular messages may be associated with a particular number of vibrations (e.g., one vibration could mean that the information was properly received). The meaning behind the number of vibrations may be agreed upon beforehand between the patient and the caregiver.

In step 260, conversions between analog and digital outputs may need to be performed. These analog-to-digital conversions may be provided so that the sensor data obtained by the module device may be transformed into information that may be evaluated and displayed by the wearable device of the caregiver and viewed by the caregiver.

In step 265, the information from the caregiver module may be provided to one or more output devices (e.g., vibrator, speaker). As noted above, not only may the information be displayed on the caregiver wearable device, the information may be provided to the user using audio and vibration. Adoption of one or more methods for providing the output of the caregiver module may be agreed upon beforehand between the patient and the caregiver.

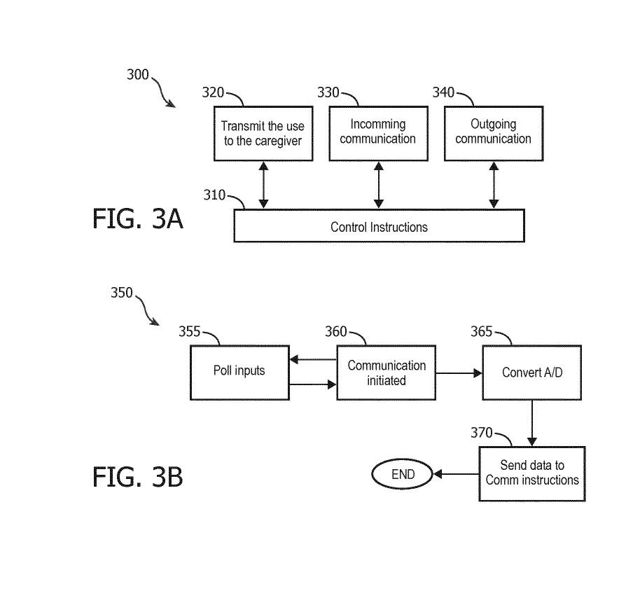

FIG. 3A illustrates example base instructions 300 for the caregiver module. As seen in the figure, the base instructions 300 may include control instructions 310 for performing a multiple different functions. The base instructions 300 may transmit information from the caregiver module to the caregiver 320 (see FIG. 2A), convert incoming communications (see FIG. 2B) and convert outgoing communication (see FIG. 3B). As described above, the base instructions 300 may transmit information from the caregiver module related to a health condition of the user 320. The information may be related to the use of an associated caregiver device (e.g., frequency of use of various medicines and/or devices for medical assistance and treatment). The base instructions 400 of the caregiver module may also control the incoming and outgoing communications 330, 340 that the caregiver module participates in. This feature may ensure that only intended parties involved in the monitoring and care of the patient receive the information from the caregiver module.

FIG. 3B illustrates example base instructions for the caregiver module for outgoing communications. In step 355, the base instructions may poll for various inputs from the caregiver module. The inputs may include sensor data monitoring use of associated caregiver devices. The base instructions may also determine if there is any available outgoing information (e.g., sensor data) that may be transmitted from the caregiver module.

In step 360, the base instructions may determine if the communication instructions is initiated. The base instructions may also determine what entities to transmit the outgoing information to. For example, the base instructions may have stored, in memory, the identity of the caregiver wearable device. Upon detecting possible outgoing communications (e.g., sensor data pertaining to patient use of the associated caregiver device), the base instructions may establish communication with the caregiver wearable device to transmit the outgoing information.

In step 365, the base instructions may perform analog-to-digital conversion of any outgoing communication from the caregiver module. The conversion may be provided in order to facilitate transmission of the communication and also to provide the communication in a form that may be recognized and understood by the caregiver.

In step 370, the outgoing communication may be provided to the communication instructions to be transmitted from the caregiver module to, for example, the caregiver wearable device. The outgoing communication may be displayed on the caregiver wearable device so that the caregiver may view the information.

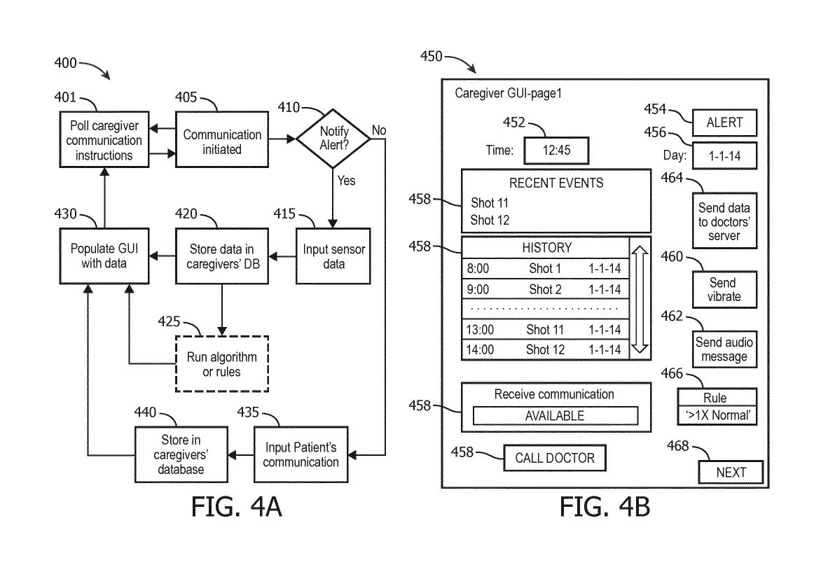

FIG. 4A illustrates example base instructions for the caregiver wearable device. The base instructions of the caregiver wearable device may be responsible for managing and executing the various functionalities of the caregiver wearable device used for remote monitoring and providing remote medical assistance to the patient.

In step 401, the base instructions may poll the caregiver communication instructions to determine if the communication instructions has been initiated. The base instructions may also poll to determine if there is any available information to obtain.

In step 405, once the communication instructions has been initiated, the base may evaluate if there are any incoming communications being provided to the caregiver wearable device. For example, the caregiver module may be providing the caregiver wearable device with information relating to the patient use of an associated caregiver device. If an incoming communication is detected, the base instructions of the caregiver wearable device may initiate communication with the particular caregiver module.

In step 410, the base instructions may evaluate if the incoming communication from the caregiver module is an alert. An alert may be indicative of an emergency arising from a medical condition of the patient that may require medical assistance or treatment.

In step 415, in the situation that an alert has been identified, the base instructions may then take the information from the caregiver module. For example, the sensor data from the caregiver module may be received by the base instructions of the caregiver wearable device. The sensor data may include information relating to the health condition of the patient. The sensor data may also include information relating to the patient use of the associated caregiver device.

In step 420, the information received from the caregiver module may then be stored by the base instructions into memory. The information may be stored for future reference by the caregiver. The information may be also provided to other entities (e.g., servers, hospitals, medical professionals) if requested from the caregiver or if the caregiver wishes to seek assistance from the other entities.

The information may also be stored so that the base instructions of the caregiver wearable device may evaluate (see step 425) the health condition of the patient or any patterns related to use of associated caregiver devices (e.g., whether the patient is taking their medicine on a regular basis). The evaluation may be based on various algorithms or rules stored in memory of the caregiver wearable device.

In step 430, the information may be displayed on the GUI of the caregiver wearable device for the caregiver to view. The information displayed may inform the caregiver as to the health of the patient and advise the caregiver to take appropriate actions if necessary (e.g., check in on the patient, call emergency services, initiate remote medical assistance/treatment).

In a situation where the information is not an alert, for example, if the caregiver module is instructed to provide information at regular intervals, the transmitted information from the caregiver module may be obtained by the base instructions (step 435) and subsequently stored in memory (step 440). This information may also be used as described above in step 430.

FIG. 4B illustrates an example caregiver GUI 450. In particular, the GUI 450, shown on the caregiver wearable device, illustrates the example situation where the caregiver device is an asthma device (as illustrated in FIG. 1). Various modifications to the GUI for when the caregiver device is a device other than an asthma device will be apparent.

The caregiver GUI 450 may include various types of information that may be used by the caregiver to evaluate a health condition of the patient. Such information may include the current time 452, an indication 454 of whether an alert is present, the current date 456, and data from caregiver module 458, 459 (e.g., when the asthma device was used by the patient). For example, a recent events area 458 may include information describing newly received uses of the caregiver device including, for example, an identifier (“Shot 11”), patient identifier, date and time of use, dosage, caregiver device identifier, etc. Alternatively, some such information may not be displayed until selection of the event for a detailed view (not shown). Similarly, a history area 458 may provide a listing of previously communicated events (including, in some embodiments, the just-received events from the recent events area 458).

The caregiver GUI 450 may also include options for specifying how notifications will be communicated to the caregiver. For example, the GUI 450 may provide a button 460 allow the caregiver to receive notification of receipt of information from the caregiver module through vibrations. In other words, the caregiver wearable device may vibrate based on the type of information received. Another button 462 may be used by the caregiver to indicate a desire to receive audio messages indicating that information has been received from the caregiver module.

The caregiver GUI 450 may also include a button 464 that allows the caregiver to communicate information about the patient with a server (e.g., doctors' server). Communication with a doctor may be beneficial if the patient or caregiver has a question and/or would like to talk to the doctor directly regarding a particular medical condition.

The GUI 450 may further include an UI element 466 for setting up customized rules. These rules may be inputted by the user (e.g., via a text entry field or a structured form, not shown) or selected from a preset list of rules. The rules may be used to evaluate whether information being received from the caregiver module should be determined as being an alert (e.g., an emergency) and indicated as such via the indication 454 or immediately communicated to the caregiver via steps 415, 420, 430 of method 400.

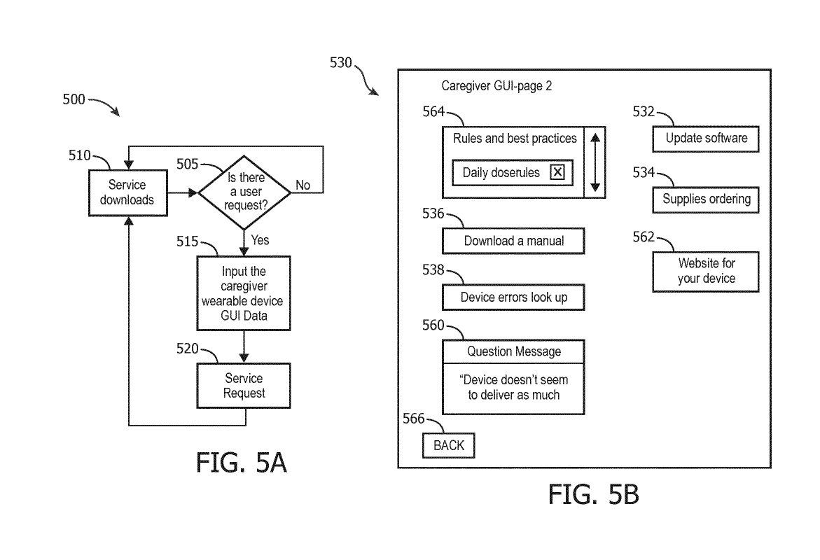

The “next” button 468 may provide the ability for the caregiver to proceed to an alternative or subsequent GUI. An example GUI accessible through the use of the “next” button 468 may be seen in FIG. 5B. Additional buttons 468, 470 may be provided for additional functionality such as, for example, accessing a communication (e.g., data, text messages, or voice) from a caregiver device or patient wearable or for initiating a call with a physician.

FIG. 5A illustrates example base instructions 500 for the caregivers health device server. In particular, the base instructions for the caregivers health device server facilitates the one or more different types of downloads that the caregiver may request from the health device server, examples of which will be described below in FIG. 5B.

Generally, the instructions 500 determines, in step 505, if there has been a request provided by the caregiver. If so, the instructions 500 processes the input caregiver wearable device GUI data in step 515. The base instructions of the caregivers health device server may receive, in step 520, any service requests from the caregiver from the access of the caregiver wearable device GUI. Such requests may include, for example, the caregiver requesting additional information about a medical condition of the patient, requesting additional historic medical data on the patient or evaluation of sensor data to determine a severity level of the health condition of the patient.

Upon receipt of the requests, and while waiting for further requests, the base instructions of the caregivers health device server may service any applicable requests in step 510. In other words, the base instructions of the caregivers health device server may service the requests that it is capable of servicing based on the information stored in the network database.

FIG. 5B illustrates another example caregiver GUI 530. In particular, the caregiver GUI illustrate in FIG. 5B may be a subsequent caregiver GUI on the caregiver wearable device as seen in FIG. 4B if the patient used the “next” button.

The caregiver GUI illustrated in FIG. 5B may also include various options that the caregiver may interact with. For example, the caregiver may select a button 532 to update the instructions stored in the caregiver wearable device from a server. The caregiver may also select a button 534 to order additional supplies (e.g., medicine) for the patient, a button 536 to download manuals containing information about a medical condition or a medical device, and a button 538 to view wearable device errors. In various embodiments, a field 540 may enable the caregiver to input text questions or requests that may be serviceable by a network. The caregiver GUI may also provide a button 562 to access to the website for the device, options 564 to download medical information (e.g., rules and best practices), and a button 566 for accessing a previous GUI page (e.g., for returning to the GUI view of FIG. 4B).

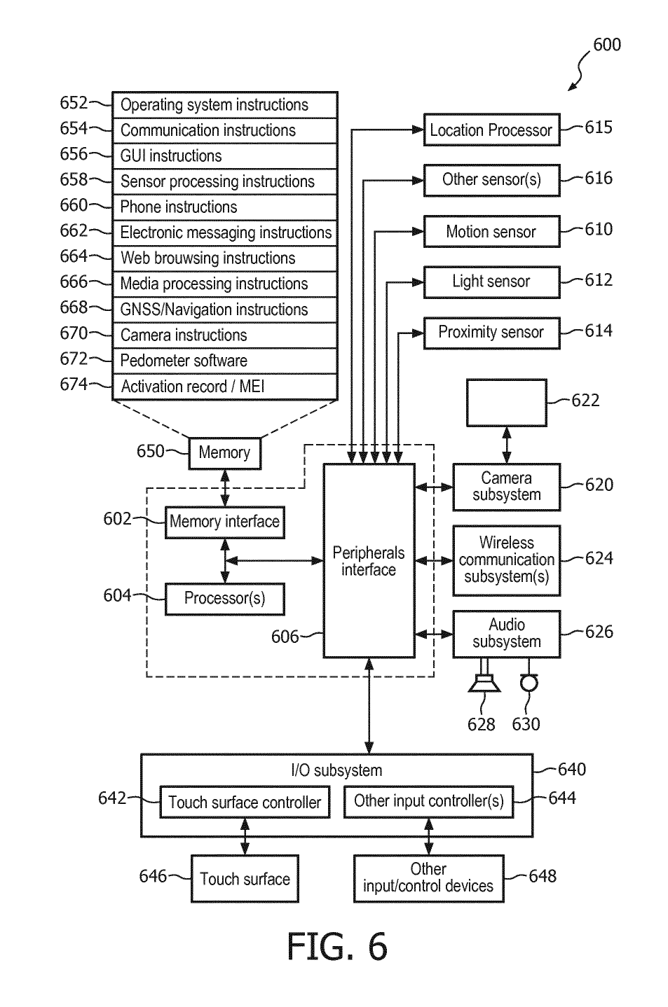

FIG. 6 illustrates an example computing device architecture that may be utilized to implement the various features and processes described herein. For example, the computing device architecture 600 may be implemented in a pedometer. In various embodiments, the architecture 600 may reflect the hardware arrangement of the caregiver wearable device 110 or patient wearable device 120 of FIG. 1. Architecture 600 as illustrated in FIG. 6 includes memory interface 602, processors 604, and peripheral interface 606. Memory interface 602, processors 604 and peripherals interface 606 may be separate components or may be integrated as a part of one or more integrated circuits. The various components may be coupled by one or more communication buses or signal lines.

Processors 604 as illustrated in FIG. 6 is meant to be inclusive of data processors, image processors, central processing units, or any variety of multi-core processing devices. Any variety of sensors, external devices, and external subsystems may be coupled to peripherals interface 606 to facilitate any number of functionalities within the architecture 600 of the exemplar mobile device. For example, motion sensor 610, light sensor 612, and proximity sensor 614 may be coupled to peripherals interface 606 to facilitate orientation, lighting, and proximity functions of the mobile device. For example, light sensor 612 could be utilized to facilitate adjusting the brightness of touch surface 646. Motion sensor 610, which could be exemplified in the context of an accelerometer or gyroscope, could be utilized to detect movement and orientation of the mobile device. Display objects or media could then be presented according to a detected orientation (e.g., portrait or landscape).

Other sensors could be may to peripherals interface 606, such as a temperature sensor, a biometric sensor, or other sensing device to facilitate corresponding functionalities. Location processor 615 (e.g., a global positioning transceiver) may be coupled to peripherals interface 606 to allow for generation of geo-location data thereby facilitating geo-positioning. An electronic magnetometer 616 such as an integrated circuit could be connected to peripherals interface 606 to provide data related to the direction of true magnetic North whereby the mobile device could enjoy compass or directional functionality. Camera subsystem 620 and an optical sensor 622 such as a charged coupled device (CCD) or a complementary metal-oxide semiconductor (CMOS) optical sensor may facilitate camera functions such as recording photographs and video clips.

Communication functionality may be facilitated through one or more communication subsystems 624, which may include one or more wireless communication subsystems. Wireless communication subsystems 624 may include 802.x or Bluetooth transceivers as well as optical transceivers such as infrared. Wired communication subsystems may include a port device such as a Universal Serial Bus (USB) port or some other wired port connection that may be used to establish a wired coupling to other computing devices such as network access devices, personal computers, printers, displays, or other processing devices capable of receiving or transmitting data. The specific design and implementation of communication subsystem 624 may depend on the communication network or medium over which the device is intended to operate. For example, a device may include wireless communication subsystem designed to operate over a global system for mobile communications (GSM) network, a GPRS network, an enhanced data GSM environment (EDGE) network, 802.x communication networks, code division multiple access (CDMA) networks, or Bluetooth networks. Communication subsystem 624 may include hosting protocols such that the device may be configured as a base station for other wireless devices. Communication subsystems may also allow the device to synchronize with a host device using one or more protocols such as TCP/IP, HTTP, or UDP.

Audio subsystem 626 may be coupled to a speaker 628 and one or more microphones 630 to facilitate voice-enabled functions. These functions might include voice recognition, voice replication, or digital recording. Audio subsystem 626 in conjunction may also encompass traditional telephony functions.

I/O subsystem 640 may include touch controller 642 and/or other input controller(s) 644. Touch controller 642 may be coupled to a touch surface 646. Touch surface 646 and touch controller 642 may detect contact and movement or break thereof using any of a number of touch sensitivity technologies, including but not limited to capacitive, resistive, infrared, or surface acoustic wave technologies. Other proximity sensor arrays or elements for determining one or more points of contact with touch surface 646 may likewise be utilized. In one implementation, touch surface 646 may display virtual or soft buttons and a virtual keyboard, which may be used as an input/output device by the user.

Other input controllers 644 may be coupled to other input/control devices 648 such as one or more buttons, rocker switches, thumb-wheels, infrared ports, USB ports, and/or a pointer device such as a stylus. The one or more buttons (not shown) may include an up/down button for volume control of speaker 628 and/or microphone 630. In some implementations, device 600 may include the functionality of an audio and/or video playback or recording device and may include a pin connector for tethering to other devices.

Memory interface 602 may be coupled to memory 650. Memory 650 may include high-speed random access memory or non-volatile memory such as magnetic disk storage devices, optical storage devices, or flash memory. Memory 650 may store operating system 652, such as Darwin, RTXC, LINUX, UNIX, OS X, ANDROID, WINDOWS, or an embedded operating system such as VxWorks. Operating system 652 may include instructions for handling basic system services and for performing hardware dependent tasks. In some implementations, operating system 652 may include a kernel.

Memory 650 may also store communication instructions 654 to facilitate communicating with other mobile computing devices or servers. Communication instructions 654 may also be used to select an operational mode or communication medium for use by the device based on a geographic location, which could be obtained by the GPS/Navigation instructions 668. Memory 650 may include graphical user interface instructions 656 to facilitate graphic user interface processing such as the generation of an interface; sensor processing instructions 658 to facilitate sensor-related processing and functions; phone instructions 660 to facilitate phone-related processes and functions; electronic messaging instructions 662 to facilitate electronic-messaging related processes and functions; web browsing instructions 664 to facilitate web browsing-related processes and functions; media processing instructions 666 to facilitate media processing-related processes and functions; GPS/Navigation instructions 668 to facilitate GPS and navigation-related processes, camera instructions 670 to facilitate camera-related processes and functions; pedometer instructions 672 to process data received from a pedometer sensor; activation record or international mobile station equipment identity (IMEI) 674 for identifying the device 600 to other networked devices; and instructions for any other application (not shown) that may be operating on or in conjunction with the mobile computing device. Memory 650 may also store other instructions for facilitating other processes, features and applications, such as applications related to navigation, social networking, location-based services or map displays.

Each of the above identified instructions and applications may correspond to a set of instructions for performing one or more functions described above. These instructions need not be implemented as separate instructions programs, procedures, or modules. Memory 650 may include additional or fewer instructions. Furthermore, various functions of the mobile device may be implemented in hardware and/or in instructions, including in one or more signal processing and/or application specific integrated circuits.

Certain features may be implemented in a computer system that includes a back-end component, such as a data server, that includes a middleware component, such as an application server or an Internet server, or that includes a front-end component, such as a client computer having a graphical user interface or an Internet browser, or any combination of the foregoing. The components of the system may be connected by any form or medium of digital data communication such as a communication network. Some examples of communication networks include LAN, WAN and the computers and networks forming the Internet. The computer system may include clients and servers. A client and server are generally remote from each other and typically interact through a network. The relationship of client and server arises by virtue of computer programs running on the respective computers and having a client-server relationship to each other.

One or more features or steps of the disclosed embodiments may be implemented using an API that may define one or more parameters that are passed between a calling application and other instructions code such as an operating system, library routine, or a function that provides a service, that provides data, or that performs an operation or a computation. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call. API calls and parameters may be implemented in any programming language. The programming language may define the vocabulary and calling convention that a programmer will employ to access functions supporting the API. In some implementations, an API call may report to an application the capabilities of a device running the application, such as input capability, output capability, processing capability, power capability, and communications capability.

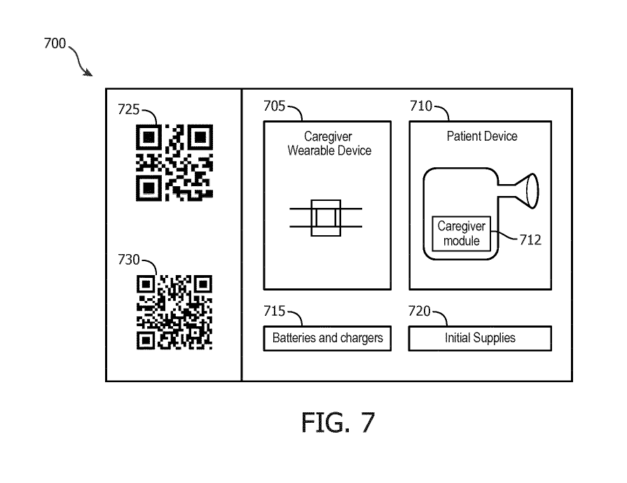

FIG. 7 illustrates an example caregiver wearable kit 700. The caregiver wearable kit 700 may be used for each caregiver-patient pair. For example, the caregiver wearable kit may include the caregiver wearable device 705 and a corresponding patient device 710 (as illustrated in FIG. 1) used to provide communication between the caregiver and the patient. The communication may facilitate remote monitoring and remote medical assistance as described above.

The caregiver wearable kit may also include supplies, for example, batteries and chargers 715 for the wearable devices as well as initial supplies 720 (e.g., medicine) for medical treatment of the patient. The caregiver wearable kit may further contain quick response (QR) codes 725, 730 (e.g., printed on the kit packaging or one or more inserts) that provide access to the caregiver servers (e.g., caregiver health server and doctors' server, respectively) where information may be downloaded for various medical conditions. In particular, the caregiver may use the QR codes 725, 730 to set up the wearable devices of this caregiver wearable kit to monitor a particular medical condition of the patient.

The QR codes 725, 730 may be beneficial to establish a particular patient profile for a corresponding caregiver wearable kit in a particular network. In this way, information associated with the patient may have a unique identification in the network. Additionally, in situations where a caregiver is required to monitor multiple patients, the QR 725, 730 codes may uniquely identify each patient (e.g., by uniquely identifying the patient device 710) on the caregiver wearable device. In this way, the caregiver may quickly know which data corresponds to which patient.

According to various embodiments, the caregiver module 712, whether provided in combination with the patient device 710 or as a separate component to be attached to the patient device 710 (e.g., as an after-market attachment), is configured to contact a predetermined location upon initial activation or power on. For example, the memory of the caregiver module may be provided with an IP address of a “home base” server (e.g., a cloud based device management system deployed to manage the many deployed caregiver modules) that is to be contacted when the caregiver module 712 does not have any other devices to which to send reports. Upon “calling home” in this manner, the home server may provide the caregiver module 712 with one or more addresses or other identifiers of devices to which raw sensor data or other data should be transmitted (e.g., an address of a patient wearable device or a caregiver wearable device). Thereafter, the patient device 710 may store these received addresses and transmit sensor data to the associated devices as appropriate.

The establish the caregiver wearable device 705 (or another device) as a device to which sensor data is to be transmitted, the caregiver wearable device 705 may scan on of the QR codes 725, 730, thereby causing the caregiver wearable device 705 to transmit a resource request, including an identifier of the patient device 710 and the caregiver wearable device 705's address or other identifier, to a server such as the home server. Thereafter, the home server may provide this address or other identifier to the patient device 710 in the manner described above. In some embodiments, the home server may require the patient's approval prior to sending the address or other identifier to the patient device. Accordingly, the home server may transmit to the patient associated with the patient device (e.g., via email, a web portal, directly to a mobile app, or to the caregiver module 712 itself) an identification of the requesting caregiver wearable device 705 (or other device) and a request to approve or deny the requested link. Thereafter, if the patient approves the request, the address or other identifier will be loaded into the caregiver module 712.

In some such embodiments, the first QR code 725 may be used to link the caregiver module 712 to the patient's own wearable and other devices. Upon scanning the first QR code 725, the home server may not require approval prior to establishing the link. Thereafter, the second QR code 730 may be used to establish links with devices operated by parties other than the patient and may prompt the home server to transmit the approval request to one or more devices previously linked via the first code 725.

As noted above, in various embodiments, the caregiver module 712 transmits only raw or partially-processed sensor data to the caregiver wearable device 705 or another device which, in turn, interprets the received data. Accordingly, in various embodiments, link establishment also includes configuring the caregiver wearable device 705 to properly interpret the incoming data. In some such embodiments, in addition or alternative to the other functions described herein, scanning a QR code 725, 730 may cause the caregiver wearable device 705 (or other device) to request instructions for interpreting the reported sensor data. The server to which the request is directed may then provide such requested instructions in the form of, for example, an app (or pointer thereto) designed for the specific patient device 710 to which the caregiver module is connected 712 or a set of rules to be used by the caregiver wearable base instructions 111 or an app that generally processes data received from any caregiver module regardless of the patient device to which it is connected.

It will be appreciated that, while QR codes are described as being used to establish a link between a caregiver or patient wearable device an a patient device, various alternative methods of establishing such a link will be apparent such as, for example, bar codes and other optical indicia, codes to be manually typed into one of the devices, or wired or wireless communication such as NFC or Bluetooth Low Energy communication. Various modifications to the processes described herein to use these alternatives will be apparent. For example, in some embodiments, the caregiver module 712 may include a memory with a pointer to an app or data defining one or more data processing rules. The caregiver module 712 may transmit this information stored in memory over NFC or other wireless technology to the caregiver wearable device 705 when the devices are in communication range to effect configuration of the caregiver wearable device 705 to process the incoming data. In a similar manner, the caregiver wearable device 705 may transmit its own address or other identifier directly to the caregiver module 712 via NFC or other wireless communication.

In various embodiments, the devices to which the caregiver module transmits sensor data may change based on, for example, the time of day or location of the patient device. In some such embodiments, upon entering a predefined geo-fence, the device may begin transmitting data to an alternative or additional device. For example, if a child patient carrying an autoinjector arrives within a geofence associated with the patient's school, the autoinjector may decide that any sensor data (which may tend to show device activation) should be transmitted to a wearable device of the school nurse in addition to the wearable devices of patient's parents, which are configured to always receive sensor data. Such a geofence may be, for example, pushed to the caregiver module 712 by the home server or may be programmed into the caregiver module 712 via a GUI similar to those described herein. The caregive module 712 may use an onboard GPS system or other location system to determine when the patient device 710 has entered each programmed geofence. Alternatively, such determination may be made by a wearable device or mobile device carried by the patient. Various alternative methods of determining the location of the patient device 710 will be apparent. For example, the location (e.g., the school) may be provided with a beacon that informs the caregiver module that it is within range of the beacon and, therefore, located at the associated location.

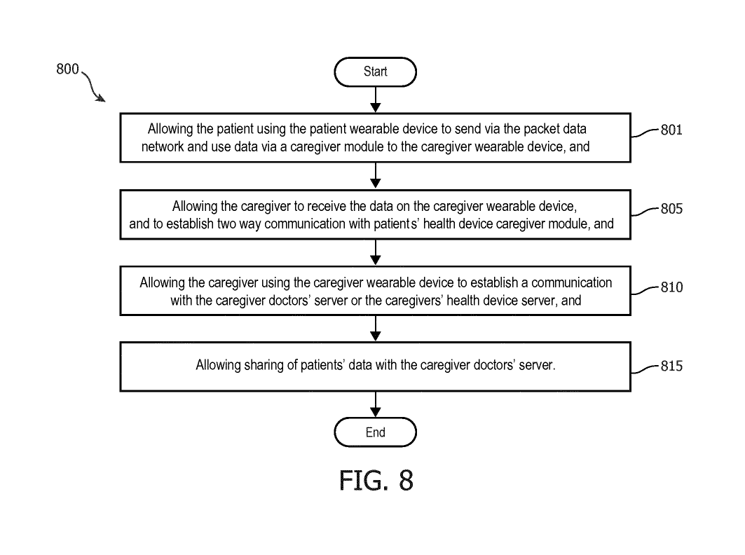

FIG. 8 illustrates an overall method 800 for providing a caregiver connected wearable device. In particular, the method is directed at providing a way for a caregiver to remotely monitor the health of the patient and the patient use of associated caregiver devices.

In step 801, information regarding the health care of the patient may be provided to the caregiver wearable device. The information may include sensor data from the patient wearable device monitoring biometric parameters of the patient. The information may also include data from one or more caregiver modules. In particular, the information from the caregiver modules may be used to determine the patient use of associated caregiver devices.

In step 805, the caregiver receives the information from the patient (e.g., from the wearable device and/or the caregiver modules). The caregiver may then establish communication with the patient. This communication may be used by the caregiver to follow up with the patient. The caregiver may monitor the health condition of the patient. The patient may likewise communicate with the caregiver and provide updates regarding the health care of the patient as perceived by the patient.

In step 810, the caregiver may establish communication with one or more servers. Communication with the networks may be provided to obtain additional information regarding the medical condition of the patient. The caregiver may also seek additional information regarding the patient (e.g., historic medical data).

In step 815, the caregiver may seek to share information received from the patient with one or more servers. The servers may be able to evaluate the health condition of the patient based on data received by the caregiver from the patient. The servers may also request additional information in the case that an emergency situation has arisen due to the medical condition. The additional information provided by the caregiver may be used to better evaluate the current condition of the patient and inform initial assistance or treatment performed by emergency services (e.g., first responders).

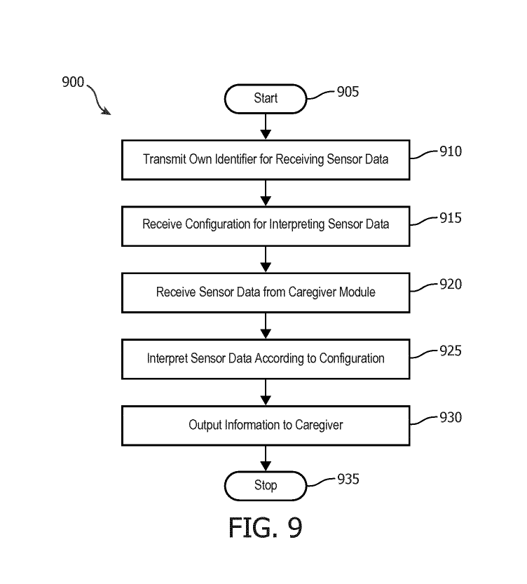

FIG. 9 illustrates and example method 900 for establishing and utilizing a link between a caregiver wearable device and a caregiver module. In various embodiments, the method 900 may be performed by a caregiver device to begin receiving and processing data from one or more caregiver modules attached to patient medical devices. For example, the method 900 may be performed through execution of the caregiver wearable base instructions 111 of FIG. 1. The method begins in step 905 and proceeds to begin link establishment in step 910 where the caregiver device transmits its own identifier to another device to indicate that sensor data is to be transmitted to the caregiver wearable device. In various embodiments, the transmitted identifier may be an IP address, MAC address, global device identifier, caregiver name or ID, or other information sufficient to uniquely identify the caregiver wearable device. The device to which the identifier is transmitted may include different devices in different embodiments. In some embodiments, the caregiver wearable may transmit its identifier directly to the caregiver module via, for example, NFC or Bluetooth communication. In some embodiments, the caregiver wearable may transmit its identifier to a home server, such as one or more virtual machines within a cloud computing architecture configured to manage device locations, reporting permissions, or routing of sensor data between devices. The caregiver wearable may be preconfigured with the address of the home server or may receive the home server address from elsewhere such as directly from the caregiver module or from indicia such as a QR code or bar code or manual input from the caregiver.

In step 915, the caregiver wearable receives configuration information for use in interpreting received sensor data. As explained above, in various embodiments, the caregiver module may transmit raw or otherwise not fully-processed sensor data to the caregiver wearable. For example, an analog-to-digital converter may convert an analog sensor signal to digital data representative of the original analog data such as, for example, a number representing a voltage received from the sensor, a number representing an observed change in voltage, a Boolean value indicating whether a signal was received from the sensor, or a Boolean value indicating whether the signal is greater or less than a predetermined threshold. Such sensor data may not be expressed in terms that are alone useful to the caregiver wearable device or wearing caregiver. For example, a voltage from an unknown sensor does not indicate what event has occurred without combining this with knowledge of what the sensor is, to what device it is attached, and how such attachment is achieved. The configuration information received in step 915 may be information sufficient for the caregiver wearable device to fully interpret the sensor data it will be receiving. For example, the configuration information may be code instructions or rules to be evaluated and executed by rule engine instructions already stored in the caregiver wearable device that instruct the caregiver wearable device as to what the sensor data means or otherwise how to process the sensor data. As another example, the configuration information may include a description of the sensors included in the caregiver module (such as a list of sensor descriptions of an identifier associated with a predetermined sensor arrangement) with which a link is being established. In such embodiments, the caregiver wearable device may be provided with instructions for interpreting many different sensors or arrangements thereof and, using the configuration information, may select the appropriate portion of the instructions for processing the sensor data. The configuration information may be received from various devices such as, for example, from the caregiver module (e.g., via NFC or Bluetooth communication), from the home server (e.g., in response to the transmission of step 910), from another server (e.g., an application marketplace server identified by the home server in response to the transmission of step 910), or manually input by the caregiver.

After step 915, linking may be complete (from the caregiver wearable device point of view) and the caregiver wearable device may begin (or resume) normal operation. In step 920, the caregiver wearable device may receive sensor data from the caregiver module (e.g., pushed or pulled via a packet network such as the Internet or via a wearable device infrastructure implemented in, for example, a cloud computing architecture). Next, in step 925, the caregiver wearable device uses the previously received configuration information to interpret the received sensor data. For example, the caregiver wearable may apply a rule associated with the sending caregiver module or may execute instructions identified by the configuration information to determine whether any information should be output to the caregiver or whether any other actions should be taken. Next, in step 930, the caregiver wearable device outputs any appropriate information to the caregiver such as, for example, a message informing the caregiver that a specific medical device has been activated. The method then proceeds to end in step 935.

Thus, various embodiments enable a modular system that allows a caregiver wearable to be linked with many different types of caregiver modules which are configured to report sensor data, but not to process such sensor data themselves into more actionable information. By receiving configuration information, the caregiver wearable device can be adapted to process the sensor data of any of a set of caregiver module types (or attached medical device types) in a meaningful way without prior knowledge of the specific caregiver module(s) to which the caregiver wearables will be linked. It will be apparent that various modifications to this method 900 are possible. For example, in some embodiments, the method 900 may be adapted for linking a caregiver module to a patient wearable device, such that the patient wearable device performs some processing of the reported sensor data either for local use or prior to transmitting the processed data to the caregiver wearable device.

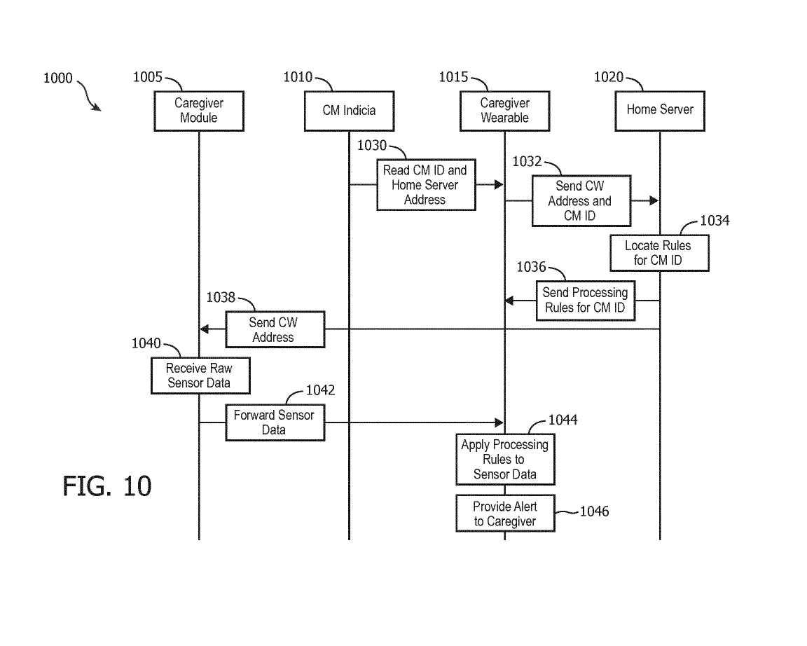

FIG. 10 illustrates an example message exchange 1000 for establishing and utilizing a link between a caregiver wearable device and a caregiver module. This message exchange 1000 may represent an example implementation of the method 900 for establishing and utilizing a caregiver wearable to caregiver module link. According to this exchange 1000, a caregiver module 1005 and associated caregiver module indicia 1010 may be used to establish a link with a caregiver wearable 1015, as facilitated by a home server 1020.

Initially, in step 1030, the caregiver wearable 1015 reads a caregiver module (CM) identifier and an address of the home server 1020 from the CM indicia 1010. For example, the CM indicia 1010 may be a QR code including a URL that points to the home server and includes the CM ID embedded therein. Alternatively, the CM indicia may be a bar code or alphanumeric characters including similar information. As another alternative, similar information may be received (e.g., electronically) from the caregiver module 1005 directly, without use of any CM indicia 1010. After reading the CM ID and home server address, the caregiver wearable (CW) transmits its own identifier to the home server along with the CM ID in step 1032. For example, step 1032 may involve sending a resource request to a URL carried by the CM indicia 1010 and the source address may constitute the CW ID. Alternatively, the caregiver wearable 1015 may insert another identifier into the request message.

In step 1034, the home server 1034 locates one or more rules associated with the received CM ID. For example, the CM ID may include a CM type identifier embedded therein or associated therewith at the home server 1020 which is correlated at the home server 1020 with a set of rules; or the full CM ID may be associated with a set of rules specific to that unique CM (e.g., as may have been previously defined by the caregiver, the patient, a physician, etc. for the caregiver device via a web portal or other interface to the home server 1020). Alternatively, instead of rules, the home server 1020 may locate alternative configuration information or a pointer thereto for transmission to the caregiver wearable. In step 1036, the home server 1020 transmits the located rules (or other configuration information) to the caregiver wearable 1015.

Next, in step 1038, the home server 1020 transmits the current address of the CW to the caregiver module 1005 for future use in reporting sensor data. In various embodiments, the home server may push the CW address 1038 to the CM 1005 while, in other embodiments, the CM 1005 may request the CW address in a power-on registration message (not shown) or in another message requesting the CW address (not shown). In some embodiments, before sending the CW address, the home server 1020 may request the patient's approval to establish the link (not shown) via, for example, the CM 1005 or another device known to be associated with the patient. In such embodiments, the home server 1020 may not send the CW address until receiving positive approval to do so from the patient. In network environments where the address of the caregiver wearable is dynamic (e.g., where the address I an IP address), the caregiver wearable 1015 may occasionally report its address (e.g., periodically based on a time interval or upon address change) to the home server 1020 which may then propagate the address to the caregiver module 1005. Alternatively, in some embodiments, the caregiver module 1005 may not be given an address and, instead, transmit sensor data to the home server 1020, which then, based on its knowledge of the established link (e.g., as stored locally or reported by the caregiver module) and the caregiver wearable's 1015 current address, forward the sensor data to the caregiver wearable 1015.

During normal operation, the caregiver module 1005 will receive sensor data from one or more of its sensors in step 1040. Then, in step 1042, the caregiver module 1005 transmits the sensor data 1042 to the caregiver wearable 1015 based on the CW address received in step 1038 (or via the home server 1020). Having received sensor data, the caregiver wearable 1044 applies the processing rules received in step 1036 (or otherwise utilizes received configuration information) to process the sensor data and, in step 1046, outputs an alert to a caregiver or performs other appropriate actions based on the outcome of step 1046.

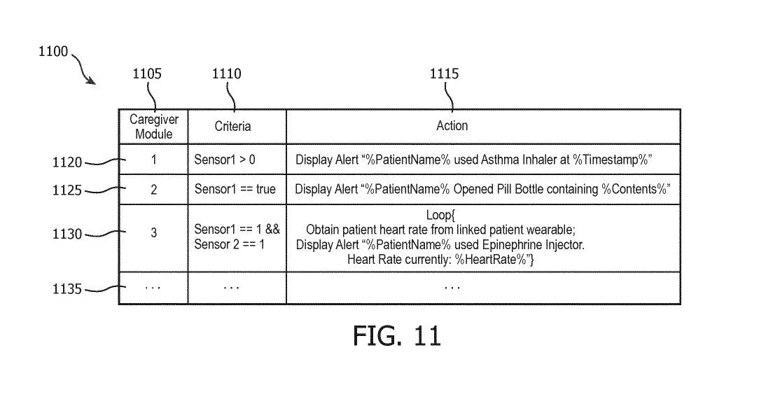

FIG. 11 illustrates an example rule set 1100 for a caregiver wearable to interpret received sensor data. Such rule set 110 may be, for example, rules received from a home server and stored in the caregiver wearable through one or more executions of step 1036 of FIG. 10 (i.e., in association with linking the caregiver wearable to one or more caregiver modules). As shown, the rule set 1100 includes a CM field 1105 for identifying the CM to which the rule applies, a criteria field 1110 for specifying when the rule is applicable, and an action field 1115 for specifying one or more actions to take when the rule is applicable. Various modifications for alternative embodiments will be apparent. For example, in embodiments where the caregiver module does not distinguish between multiple caregiver modules (e.g., where a 1-to-1 linking relationship is enforced or where the caregiver module links to caregiver modules of a single type), the CM field 1105 may be omitted.

As an example, a first rule 1120 indicates that, when the CM with identifier “1” reports a sensor value over 0, the CW should display an alert. It will be noted that the criteria field to be applied does not specify what the sensor is or represents because the caregiver wearable may not know what the received data represents. Instead, the CM may simply have reported the readouts of each of its unnamed sensors. Additionally, as shown, the defined alert includes two variables to be replaced with data pior to being output. The first variable, “% PatientName %” may be used to customize the alert based on information known about the caregiver module “1.” For example, if the caregiver had previous input an association between the CM “1” and the name of the patient (or other party) to which the CM and attached device belongs or is assigned, the CW may retrieve that associated name and insert it into the message. As another example, the % Timestamp % field may be used to present additional information reported by the CM. For example, where the CM reports sensor data along with a time stamp, the CW may input, into the displayed alert, the timestamp from the sensor data report that triggered application of the rule.

As another example, a second rule 1125 indicates that, when CM “2” reports sensor1 data equal to “true,” the CW should display an alert. As can be seen, even though the first two rules both reference “Sensor1” data, this data comes from different CMs (i.e., CM 1 and CM 2), and the “Sensor1” in each of these respective devices may be different sensors, may be arranged differently with respect to the attached device, or may report different types of data (e.g., numeric vs. Boolean). Thus, the rules enable the CW to interpret sensor data without other knowledge of the particular sensors from which data received. As can also be seen in the second rule 1125, the alert includes an additional variable, % Contents % which may refer to a previously input association between the CM 2 and the prescription contained in the attached pill bottle.

As a final example, a third rule 1130 indicates that, when CM “3” reports both Sensor1 and Sensor2 equal to a value of “1,” a routine should be performed. Specifically, the example defines a loop to be performed until it is stopped by, for example, manual input by the caregiver. A first statement indicates that the CW should poll a patient wearable for heart rate data. For example, the caregiver or patient may have previously provided an association between CM “3” and a heart rate monitor worn by the same patient that carries the epinephrine injector to which CM “3” is attached. Accordingly, in this step, the CW may poll the heart rate monitor (e.g., by sending a request to an address of the heart rate monitor via a network or by sending a request to a wearable device management infrastructure in a cloud computing architecture) to retrieve the patient's current heart rate. After receiving a response, the CW may display an alert, including the received heart rate in place of the variable % HeartRate %. Accordingly, in addition to providing an indication of use of the medical device, the CW may provide a real-time vital or other patient data relevant to the medical device use. As will be understood, the rule set 1100 may include numerous additional rules related to CMs 1-3 or additional CMs.

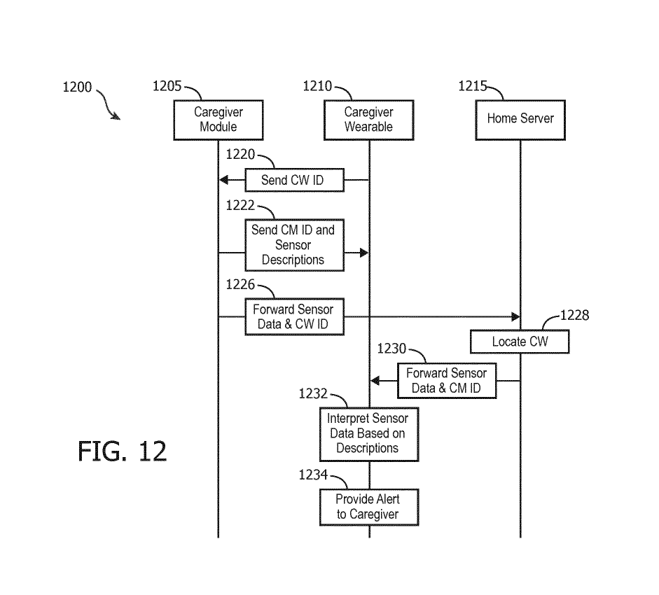

FIG. 12 illustrates an alternative example message exchange 1200 for establishing and utilizing a link between a caregiver wearable device and a caregiver module. This message exchange 1200 may represent an example implementation of the method 900 for establishing and utilizing a caregiver wearable to caregiver module link. According to this exchange 1000, a caregiver module 1005 may be used to establish a link with a caregiver wearable 1015, whereby sensor data is transmitted via a home server 1020.

In step 1220, the CW 1210 transmits its own unique identifier to the CM 1205 and, in step 1222, the CM 1205 sends its own unique identifier and a description of its sensors to the CW 1210. The information exchange in steps 1220, 1222 may occur, for example, via a wireless communication such as NFC or Bluetooth. The sensor descriptions may function as configuration information for the caregiver wearable 1210 by describing each individual sensor and what the measured values mean or by identifying a predefined set of sensors carried by the CM (e.g., an asthma inhaler sensor package, a pill bottle sensor package, etc.).

During normal operation, the CM 1205 may forward received sensor data to the home server 1215 along with the CW ID received in step 1220. Upon receiving the sensor data and CW ID, the home server 1215 looks up a current location of the CW in step 1228 (since the CW 1210 may have changed location since link establishment or the last report). For example the CW may periodically report, to the home server 1215, its current address. Upon locating the CW 12100, the home server 1210 forwards the sensor data along with the CM ID to the CW 1210 in step 1230. Based on the received CM ID, the CW 1210 retrieves the sensor description received in step 1222 and interprets the sensor data in step 1232 accordingly. For example, where the sensor description identifies a predefined package of sensors, the CW 1210 may locate code associated with that package and execute that code to interpret the sensor data. Finally, in step 1234, the CW 1210 performs any appropriate actions such as providing a medical device usage alert to the caregiver.

As will be understood, while FIGS. 10 and 12 describe two separate embodiments, that they may be modified and combine with each other or other alternatives to produce additional alternative embodiments. For example, another embodiment may utilize sensor descriptions in the manner described in connection with steps 1222 and 1232 but communicated according to an optical indicia (e.g., a symbol specific to the CM arrangement type) while reporting sensor data directly from the CM to CW in them manner described in connection with steps 1042. Various additional combinations of the various steps described herein will be apparent.

According to the foregoing, various embodiments provide an advantage of facilitating the linking of a caregiver module attached to a medical device with a wearable device of a caregiver, patient, or other party. By providing configuration information to the wearable device, it may be configured to properly interpret raw or only partially processed sensor data received from the caregiver module, which may not be capable of further processing the information into an otherwise digestible form for the wearable device or wearer thereof. Further, a linking process may be used to easily provide an identifier of the wearable to the caregiver module or a facilitating device to establish a location to which sensor data will be transmitted. By offloading sensor processing to another device in this way, a low cost caregiver module may be provided for attachment to patient medical devices. This is particularly useful when the medical devices are similarly low cost (e.g., an asthma rescue inhaler) to convert the device into a semi-intelligent device capable of reporting usage in the form of sensor data without prohibitively increasing the cost to manufacture and purchase. Additional advantages of the embodiments described herein will be apparent in view of the foregoing.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

1. A caregiver module for use in conjunction with a patient medical device, the caregiver module comprising:
a communications interface;
a memory;
a sensor configured to obtain a sensor signal related to the use of the patient medical device;
an analog-to-digital converter configured to convert the sensor signal to corresponding sensor data; and
a controller in communication with the communications interface, the memory, and the analog-to-digital converter, the controller being configured to transmit the sensor data to a wearable device via the communications interface, wherein the sensor data is transmitted in the same form as created by the analog-to-digital converter.

2. The caregiver module of claim 1, wherein the sensor signal is related to at least one of activation of an asthma inhaler, activation of an auto-injector, and opening of a pill bottle.

3. The caregiver module of claim 1, wherein:
the memory includes configuration information for instructing the wearable device in how to process the sensor data, and
the controller is configured to transmit the configuration information to the wearable device via the communications interface.

4. The caregiver module of claim 3, wherein the configuration information comprises at least one rule for application by the caregiver wearable device.

5. The caregiver module of claim 1, wherein:
the memory stores a server address, and
the controller is configured to:
transmit a registration message to the server address, and
based on receiving a response to the registration message:
extract a caregiver wearable device identifier from the response, and
store the caregiver wearable device identifier in the memory,
whereby transmission of the sensor data to a wearable device via the communications interface is performed based on the stored caregiver wearable device identifier.

6. The caregiver module of claim 5, wherein:
the caregiver module further comprises a user interface for communicating with a user of the patient medical device, and
the controller is further configured to:
in response to receiving an link approval request via the communications interface and associated with the caregiver wearable device, request an approval response from the user via the user interface, and
transmit an indication of the user's approval response to the communications interface,
whereby the response to the registration message is received after transmitting the indication of the user's approval.

7. The caregiver module of claim 1, wherein:
the memory stores an identification of a physical location and an associated secondary caregiver wearable device, and
the controller is further configured to:
determine whether the caregiver module is currently located at the physical location, and
when the caregiver module is currently located at the physical location, additionally transmit the sensor data to the secondary wearable device via the communications interface.

8. A kit comprising:
a patient medical device;
the caregiver module of claim 1 configured for attachment to the patient medical device; and
linking indicia configured to be read by the caregiver wearable device and to cause a link to be created between the caregiver module and the caregiver wearable device.

9. The kit of claim 8, wherein creation of the link comprises providing the caregiver module with an identifier of the caregiver wearable device, whereby transmission of the sensor data to a wearable device via the communications interface is performed based on the stored caregiver wearable device identifier.

10. The kit of claim 8, wherein, in causing a link to be created, the linking indicia is configured to cause configuration instructions to be downloaded onto the caregiver wearable device, wherein the configuration instructions configure the caregiver wearable device to interpret the sensor data.

11. A wearable device for processing sensor data received from a caregiver module, the wearable device comprising:
a communication interface;
a memory storing processing instructions for interpreting sensor data of multiple types; and
a processor in communication with the communication interface and the memory, the processor being configured to:
receive configuration information associated with a caregiver module,
receive, via the communications interface, sensor data of a first type from the caregiver module, and
execute the processing instructions based on the received configuration information, wherein the configuration information alters the operation of the processing instructions to interpret sensor data of the first type.

12. The wearable device of claim 11, wherein:
the processing instructions define a rules engine, and
the configuration information comprises at least one rule for execution by the rules engine and that is specific to sensor data of the first type.

13. The wearable device of claim 11, wherein:
the processing instructions comprise first processing instructions for processing sensor data of the first type and second processing instructions for processing sensor data of the second type, and
in executing the processing instructions based on the received configuration information, the processor is configured to execute the first processing instructions based on the configuration information indicating that the sensor data is of the first type.

14. The wearable device of claim 11, wherein the processor is configured to receive the configuration information from the caregiver module via the communication interface using a short range wireless communication.

15. The wearable device of claim 11, wherein the processor is configured to:
receive an identification of a server from at least one of the caregiver module and an indicia associated with the caregiver module, and
request the configuration information from the server based on receiving the identification of the server.
